(19) United States
(12) Patent Application Publication
(10) Pub. No.: US 2026/0169141 A1
(43) Pub. Date: Jun. 18, 2026

(54) CONTROL DEVICE AND OPERATING METHOD FOR AN ULTRASONIC SENSOR, ULTRASONIC SENSOR, SET COMPRISING CONTROL DEVICE AND ULTRASONIC SENSOR AND MOTOR VEHICLE

(71) Applicant: VALEO SCHALTER UND SENSOREN GMBH, Bietigheim-Bissingen (DE)

(72) Inventors: Michael Hallek, Bietigheim-Bissingen (DE); Fabian Haag, Bietigheim-Bissingen (DE)

(73) Assignee: VALEO SCHALTER UND SENSOREN GMBH, Bietigheim-Bissingen (DE)

(21) Appl. No.: 19/123,546

(22) PCT Filed: Oct. 17, 2023
(86) PCT No.: PCT/EP2023/078756

§ 371 Date: Apr. 23, 2025

(30) Foreign Application Priority Data
Oct. 24, 2022 (DE) 10 2022 127 998.7

(51) Int. Cl. G01S 7/52; G01S 7/521; G01S 15/88

(52) U.S. Cl. CPC G01S 7/52004; G01S 7/521; G01S 15/88; G01S 2007/52007; G01S 2007/52009

(57) ABSTRACT

A control device for an ultrasonic sensor of a motor vehicle is disclosed herein. The control device includes a first unit configured to determine a sensor characteristic of the ultrasonic sensor during routine operation of the motor vehicle; a second unit configured to assess the determined sensor characteristic to the effect of whether an operating parameter of the ultrasonic sensor is to be adapted; and a third unit configured to adapt the operating parameter of the ultrasonic sensor on the basis of the determined sensor characteristic if the second unit assesses that the operating parameter is to be adapted.

The present invention relates to a control device for an ultrasonic sensor, a method for operating an ultrasonic sensor, an ultrasonic sensor, a set comprising the control device and the ultrasonic sensor, and a motor vehicle.

Modern motor vehicles are equipped with ultrasonic sensors which allow an environment of the motor vehicle to be measured by transmitting and receiving an ultrasonic signal. The information obtained in this way relating to the environment of the vehicle can be evaluated by a driver assistance system in order to generate warnings for the driver and to enable autonomous parking or partially or fully autonomous driving.

An ultrasonic diaphragm of the ultrasonic sensor, which transmits and receives the ultrasonic signals, is mounted flush with an outer skin of the motor vehicle and is therefore visible from the outside. The customer accordingly wishes for the ultrasonic diaphragm to be painted in the same color as the outer skin of the motor vehicle.

The mass and rigidity of the ultrasonic diaphragm are changed by painting. The resonance frequency and/or the conversion efficiency of the ultrasonic diaphragm also changes accordingly, which must be taken into account when operating the ultrasonic sensor.

Ultrasonic sensors are conventionally painted and calibrated in large-scale production during the manufacture of the ultrasonic sensor, i.e. by the supplier. The respective ultrasonic sensor is already calibrated by the supplier on the basis of a painted prototype of the respective large-scale production, which is examined under laboratory conditions.

However, a customer may subsequently wish to have his automobile repainted in a different color. It is also not logistically feasible to keep a stock of ultrasonic sensors with all possible paint coatings as spare parts in the aftermarket. In addition, premium vehicle manufacturers sometimes produce small series with special paint coatings for which ordering a prepainted ultrasonic sensor in large-series production would be uneconomical.

DE 20 2004 021 873 U1 discloses a diaphragm pot for an ultrasonic transducer having a wall to carry a diaphragm that is excitable to produce vibrations, wherein the diaphragm pot is provided with a galvanic coating at least in the area of the diaphragm at least on the outside of the diaphragm pot. The diaphragm thickness is selected such that the diaphragm pot has a specified resonance frequency following the application of the galvanic layer.

EP 1 855 093 A1 discloses a method for adjusting the resonance frequency of an oscillation section of an ultrasonic sensor housing. The method comprises measuring the resonance frequency of the oscillation section with a measuring device; comparing the measured resonance frequency with a predefined threshold value of a target resonance frequency; and performing a material removal or application on the oscillation section based on the comparison in order to adjust the resonance frequency of the oscillation section.

Against this background, one object of the present invention is to enable the painting of ultrasonic sensors after leaving the manufacturer's premises.

According to a first aspect, a control device for an ultrasonic sensor of a motor vehicle is proposed for achieving the object, having: a first unit configured to determine a sensor characteristic of the ultrasonic sensor during routine operation of the motor vehicle; a second unit configured to assess the determined sensor characteristic in order to establish whether an operating parameter of the ultrasonic sensor is to be adapted; and a third unit configured to adapt the operating parameter of the ultrasonic sensor based on the determined sensor characteristic if the second unit assesses that the operating parameter is to be adapted.

If a motor vehicle is fitted with the proposed control device, the control device can recalibrate the ultrasonic sensor during routine operation of the motor vehicle if the ultrasonic sensor has been repainted, for example by an owner of the motor vehicle, by a repair workshop when an aftermarket spare part is installed or during small series production after leaving the factory of the manufacturer of the ultrasonic sensor. Changes in the properties of the ultrasonic diaphragm due to the repainting can therefore be calibrated out, and an unchanged high performance of the ultrasonic sensor can advantageously be maintained.

In particular, “routine operation of the motor vehicle” means that no laboratory conditions exist during the performance of the proposed functionality of determining and assessing a sensor characteristic and adapting the operating parameter depending on the assessment. The proposed functionality of the control device units is therefore not a diagnostic functionality that is only activated in workshop mode, but is instead an operational functionality. The proposed functionality can be performed routinely, for example after every actuation of an ignition or a start button of the motor vehicle, or after every activation of the control device, or the like. Real conditions therefore exist when the proposed functionality is performed. This means that an obstacle could be present in the field of view of the ultrasonic sensor, and the ultrasonic sensor could also be dirty, damaged or iced up. “Routine operation” also refers in particular to the intended use of the motor vehicle after its manufacture.

Determining the sensor characteristic comprises, in particular, measuring the sensor characteristic.

The phrase “assess whether an operating parameter of the ultrasonic sensor is to be adapted” can comprise assessing whether an adaptation of the ultrasonic sensor is necessary and/or assessing whether an adaptation of the ultrasonic sensor is possible and expedient.

For example, an adaptation of the ultrasonic sensor may only be necessary if the sensor characteristic of the ultrasonic sensor has changed. For example, an adaptation of the ultrasonic sensor may be possible and expedient only if the ultrasonic sensor is not dirty, iced up or obscured by an obstacle.

“Adapting the operating parameter” can also mean calibrating or recalibrating the ultrasonic sensor.

The operating parameter of the ultrasonic sensor can be an operating parameter with which the control device or a further control device operates the ultrasonic sensor. However, the operating parameter of the ultrasonic sensor can also be an operating parameter which the ultrasonic sensor itself takes into account in its operation.

Accordingly, adapting the operating parameter can comprise adapting an operating parameter of the control device in question, with which the control device operates the ultrasonic sensor. Adapting the operating parameter can also comprise setting the adapted operating parameter on the ultrasonic sensor, for example by transmitting the adapted operating parameter in conjunction with a command for the adaptation or the like to the ultrasonic sensor.

Various embodiments which allow an automated assessment of the necessity, possibility and expediency of adapting the operating parameter of the control device are explained below.

According to one embodiment, the assessment by the second unit comprises determining a deviation of the determined sensor characteristic from a sensor characteristic stored in the second unit which corresponds to current operating parameter values of the ultrasonic sensor.

Accordingly, it is advantageously possible to automatically assess whether the sensor characteristic has changed and an adaptation of the operating parameter is therefore required.

For example, a sensor characteristic predefined or measured in advance—for example in the laboratory when the ultrasonic sensor or a prototype of it is manufactured—can originally be stored in the second unit. If the second unit assesses that an operating parameter is to be adapted, it can overwrite the stored sensor characteristic with the currently determined sensor characteristic or with a sensor characteristic that corresponds to the operating parameter after it has been adapted.

A sensor characteristic corresponding to the currently set operating parameter can therefore always be stored in the second unit for comparison purposes.

According to a further embodiment, the assessment by the second unit comprises assessing whether an identified deviation of the determined sensor characteristic from the stored sensor characteristic is due to a paint coating of an ultrasonic diaphragm of the ultrasonic sensor, and assessing that the operating parameter is to be adapted only if the identified deviation is due to a paint coating of the ultrasonic diaphragm.

Accordingly, a distinction can advantageously be made between a case where an adaptation of the operating parameter is expedient, i.e. if the ultrasonic sensor has been repainted, and a case where adaptation of the operating parameter is not expedient, i.e. if the sensor characteristic has changed for other reasons and/or the sensor characteristic is unsuitable for recalibration.

Examples of other reasons which are to be distinguished from a paint coating are dirt on the ultrasonic sensor, ice on the ultrasonic sensor and damage to the ultrasonic sensor.

According to a further embodiment, the second unit is configured to assess whether the operating parameter is to be adapted by comparing a first distance measurement performed with the ultrasonic sensor with a second distance measurement performed with the same or a further ultrasonic sensor.

The operating parameter is to be adapted particularly if a deviation of the determined sensor characteristic from a stored sensor characteristic is due to a paint coating. If the measurement results of two distance measurements performed in a time-related manner with the same ultrasonic sensor or with two different ultrasonic sensors differ substantially from one another, i.e. by more than a predefined threshold value, it is assumed either that a temporary obstacle is present in the vicinity of one of the ultrasonic sensors or that dirt, ice or damage is affecting one of the ultrasonic sensors and that an adaptation of the operating parameter is therefore not currently expedient. However, if the vehicle is repainted, the repainting would equally affect the measurement result of all ultrasonic sensors, and the different distance measurements would not therefore differ substantially from one another, so that an adaptation of the operating parameter may be expedient in this case.

A distance measurement can comprise, in particular, activating the ultrasonic sensor to transmit an ultrasonic signal and receiving a reflected ultrasonic signal, as well as determining a distance to an obstacle in an environment of the motor vehicle by means of a signal propagation time between the transmission of the ultrasonic signal and the reception of the reflected ultrasonic signal.

Accordingly, a simple possibility is advantageously indicated for determining automatically, even without the existence of laboratory conditions, whether an adaptation of the operating parameter is expedient because a change in the sensor characteristic is due to a paint coating.

According to a further embodiment, the second unit stores a lookup table containing a plurality of predefined sensor characteristics and associated operating parameter values that were determined in advance through measurements on differently painted ultrasonic sensors under laboratory conditions, and the second unit is configured to assess, by comparing the determined sensor characteristic with the plurality of predefined sensor characteristics, whether the operating parameter is to be adapted and/or, by referring to the lookup table, to determine an operating parameter value to which the operating parameter is to be adapted by the third unit.

It is therefore advantageously possible to paint a respective prototype of the ultrasonic sensor in the laboratory in advance with all expected paint types (e.g. with different thicknesses, material consistencies, etc.) and to determine the optimum operating parameters for each of the prototypes using laboratory measuring equipment. The information obtained in this way can advantageously be stored in the lookup table and can be used later away from the laboratory to recalibrate the ultrasonic sensor.

Accordingly, a further simple possibility is advantageously indicated which can be used, as an alternative or in addition to other possibilities disclosed here, for automatically determining whether an adaptation of the operating parameter is expedient because a change in the sensor characteristic is due to a known paint coating type, and at the same time directly indicating the operating parameter value to which the operating parameter is to be set.

In particular, it can be assessed that the operating parameter is to be adapted if the determined sensor characteristic is sufficiently similar to one of the predefined sensor characteristics and/or a sensor characteristic interpolated from a plurality of the predefined sensor characteristics. In addition, in this case, the operating parameter value to which the operating partner is to be adapted in this case can be taken directly from the lookup table and/or can be interpolated from a plurality of values taken directly from the lookup table.

According to a further embodiment, the second unit comprises a physical or data-based model configured to output an assessment, based on a sensor characteristic entered into the model, of whether an operating parameter is to be adapted, and/or to output an operating parameter value to which the operating parameter is to be adapted, and the second unit is configured to enter the determined sensor characteristic into the physical or data-based model and to use the physical or data-based model to assess whether the operating parameter is to be adapted and/or to determine an operating parameter value to which the operating parameter is to be adapted by the third unit.

Accordingly, a further possibility is advantageously indicated which can be applied as an alternative or in addition to other possibilities disclosed here in order to determine automatically, even without the existence of laboratory conditions, whether an adaptation of the operating parameter is expedient because a change in the sensor characteristic is due to a modellable paint coating, while at the same time directly determining the operating parameter value to which the operating parameter is to be set.

A physical model can, in particular, be a model based on a knowledge-based modelling of the physical interrelationships between the thickness and weight of a paint layer on the ultrasonic diaphragm, the resulting sensor characteristic and the operating parameters that are optimal for the respective sensor characteristic.

In particular, a data-based model can be a model that can be obtained using statistical methods by analyzing a multiplicity of measured sensor characteristics in different paint coatings and a multiplicity of optimal operating parameters determined through measurement, whereby parameters of the data-based model are adapted until the closest possible match is achieved between the predictions of the model and the physical reality of the multiplicity of measurements.

According to a further embodiment, the data-based model comprises one or more trained neural networks.

For example, a first of the neural networks can be trained with sensor characteristics measured on differently painted ultrasonic sensor prototypes as input data and with the optimum operating parameters determined in each case through measurement as output data. A second of the neural networks can be trained with sensor characteristics measured on differently painted ultrasonic sensor prototypes on the one hand and on differently dirtied, iced up or damaged ultrasonic sensor prototypes on the other hand, as training input data, and with a respective indication of whether the sensor characteristic in question originates from a painted ultrasonic sensor prototype or from a dirty, iced up or damaged ultrasonic sensor prototype as training output data.

Accordingly, knowledge of the physical interrelationships is advantageously not required and it is nevertheless possible to assess automatically and without the presence of laboratory conditions whether and how the operating parameter is to be expediently adapted.

According to a further embodiment, the respective sensor characteristic determined by the first unit is a transmission function of mechatronic components of the ultrasonic sensor, and the first unit is configured to impress an electrical test signal on the ultrasonic sensor and to capture an electrical response signal from the ultrasonic sensor in order to determine the sensor characteristic.

Accordingly, a purely electrical characterization of the properties of the ultrasonic sensor and its mechatronic components is performed. It is therefore advantageously not necessary to create a defined laboratory environment in order to be able to characterize the sensor. The result of determining the sensor characteristic is advantageously not dependent on whether the ultrasonic sensor is outdoors or whether, for example, a distant obstacle, such as a garage wall, obscures the ultrasonic sensor.

The electrical test signal can be a voltage signal or a current signal, and the electrical response signal can be a current signal or a voltage signal.

The transmission function can advantageously contain all the data required in order to determine the operating parameter, such as an operating frequency, a transmit signal amplitude or a receive signal gain.

The mechatronic components of the ultrasonic sensor comprise the mechatronic system, which is activated with the test signal and by which the receive signal is received, and comprise, for example, the ultrasonic diaphragm, a transducer element attached to it from the inside and a driver circuit to activate the transducer element.

According to a further embodiment, the operating parameter that is adapted by the third unit comprises one or more of the following parameters: an operating frequency at which an ultrasonic diaphragm of the ultrasonic sensor is excited to produce vibrations, an amplitude of an activation signal with which a driver circuit of the ultrasonic sensor activates a sound transducer element of the ultrasonic sensor, and an amplification with which a receive signal output by the sound transducer element to the driver circuit is amplified.

Accordingly, an adequate response to changes in the properties of the ultrasonic diaphragm due to an applied paint coating is advantageously enabled.

According to a second aspect, a method for operating an ultrasonic sensor of a motor vehicle is proposed. The method comprises: determining a sensor characteristic of the ultrasonic sensor during routine operation of the motor vehicle; assessing the determined sensor characteristic in order to establish whether an operating parameter of the ultrasonic sensor is to be adapted; and adapting the operating parameter of the ultrasonic sensor based on the determined sensor characteristic if it has been assessed that the operating parameter is to be adapted.

According to a third aspect, a computer program product is proposed, comprising instructions which, when executed by a control unit of a motor vehicle, cause the control unit to carry out the method according to the first aspect or one of its embodiments.

According to a fourth aspect, an ultrasonic sensor is proposed, having an ultrasonic diaphragm, a sound transducer element arranged on an inside of the ultrasonic diaphragm for vibration excitation and vibration detection of the ultrasonic diaphragm, a driver circuit to activate the sound transducer element, and the control device as claimed in one of claims 1 to 9.

According to one embodiment, the ultrasonic diaphragm of the ultrasonic sensor is without at least a final paint coating.

The ultrasonic diaphragm can, in particular, be unpainted.

According to a fifth aspect, a set is proposed which comprises: the control device according to the first aspect or one of its embodiments and/or the computer program product according to the third aspect and an ultrasonic sensor which has an ultrasonic diaphragm, a sound transducer element arranged on an inside of the ultrasonic diaphragm for vibration excitation and vibration detection of the ultrasonic diaphragm, and a driver circuit to activate the sound transducer element.

The ultrasonic sensor and the associated control device with the proposed recalibration functionality are preferably sold as a set, since the control device contains, for example, lookup tables or models of ultrasonic sensors of a specific type which it is configured to recalibrate.

According to one embodiment, the ultrasonic diaphragm of the ultrasonic sensor is without at least a final paint coating.

The ultrasonic diaphragm can, in particular, be unpainted.

Thanks to the features of the proposed control device, there is advantageously no need to paint the diaphragm of the ultrasonic sensor during manufacture and calibrate the ultrasonic sensor during manufacture after painting. Instead, the painting of the ultrasonic sensor can be left to the vehicle manufacturer or the customer, and this can be done only when the vehicle receives a final paint coating or is repaired.

According to a sixth aspect, a motor vehicle is proposed which has a control device according to the first aspect or one of its embodiments, an ultrasonic sensor according to the fourth aspect or one of its embodiments or a set according to the fifth aspect or one of its embodiments.

The embodiments and features described for the proposed control device apply accordingly to the proposed method, the proposed computer program product, the proposed ultrasonic sensor, the proposed set and the proposed motor vehicle.

Further possible implementations of the invention also comprise not explicitly mentioned combinations of features or embodiments described above or below with regard to the exemplary embodiments. A person skilled in the art will in this case also add individual aspects as improvements or additions to the respective basic form of the invention.

Further advantageous designs and aspects of the invention form the subject-matter of the dependent claims and of the exemplary embodiments of the invention that are described below. The invention is explained in more detail below on the basis of preferred embodiments with reference to the accompanying figures.

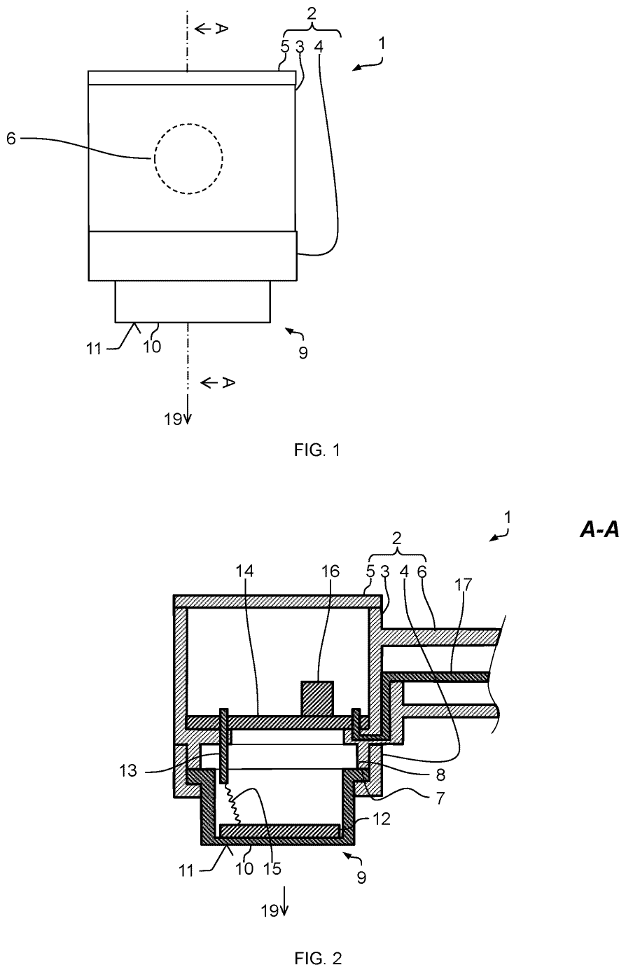

FIG. 1 shows schematically an example of an ultrasonic sensor;

FIG. 2 shows schematically a motor vehicle having the ultrasonic sensor and a control device according to one exemplary embodiment;

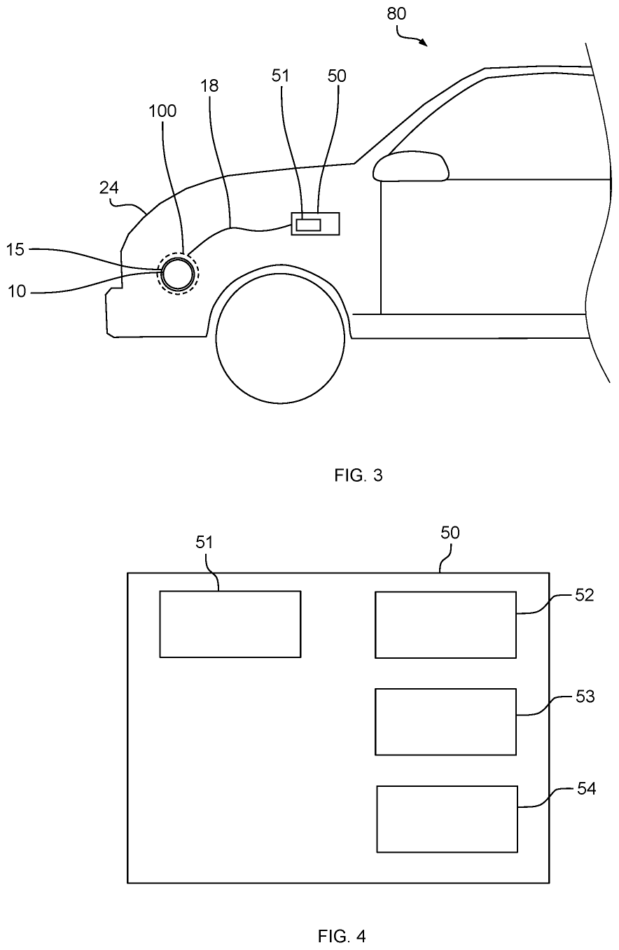

FIG. 3 shows a section A-A in FIG. 1 of the example of an ultrasonic sensor;

FIG. 4 shows an equivalent circuit diagram of the example of an ultrasonic sensor;

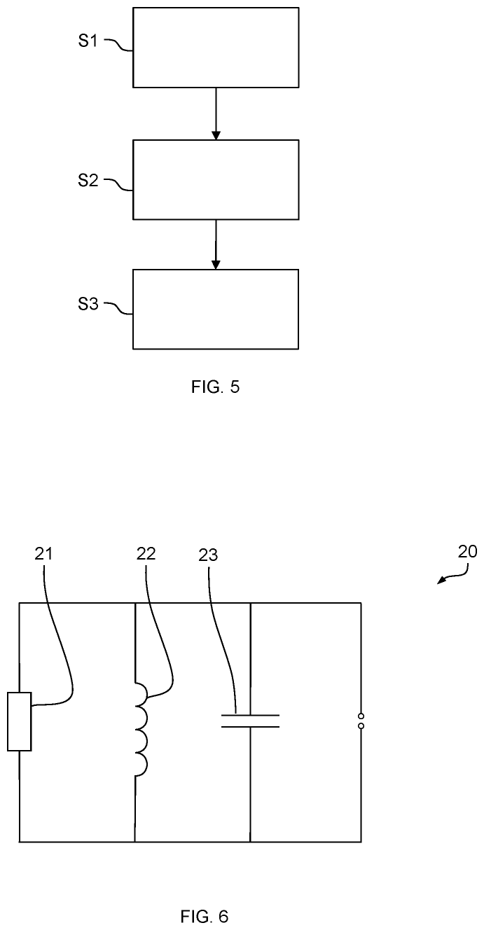

FIG. 5 shows schematically functional units of the control device according to the exemplary embodiment;

FIG. 6 illustrates steps of a method according to the exemplary embodiment;

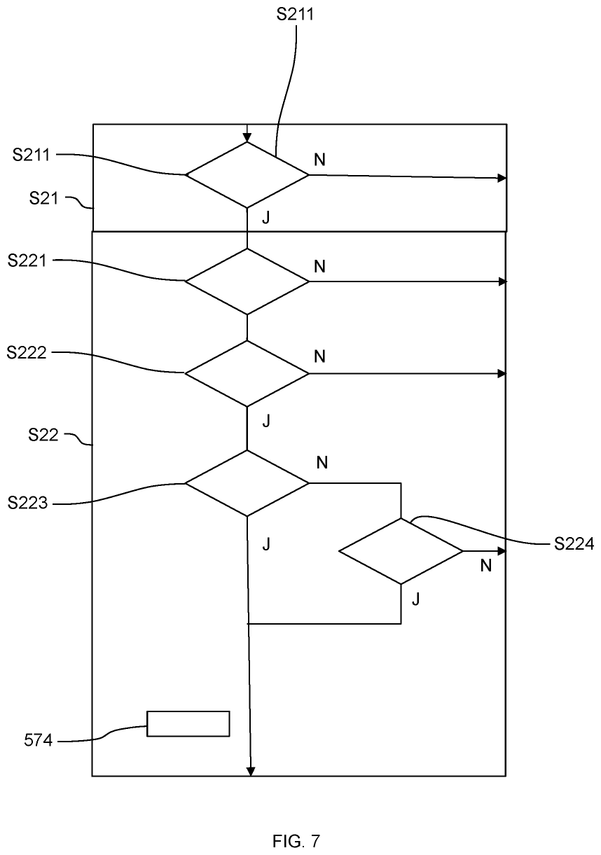

FIG. 7 shows a flow diagram illustrating the processing steps of an assessment unit according to advantageous developments of the exemplary embodiment;

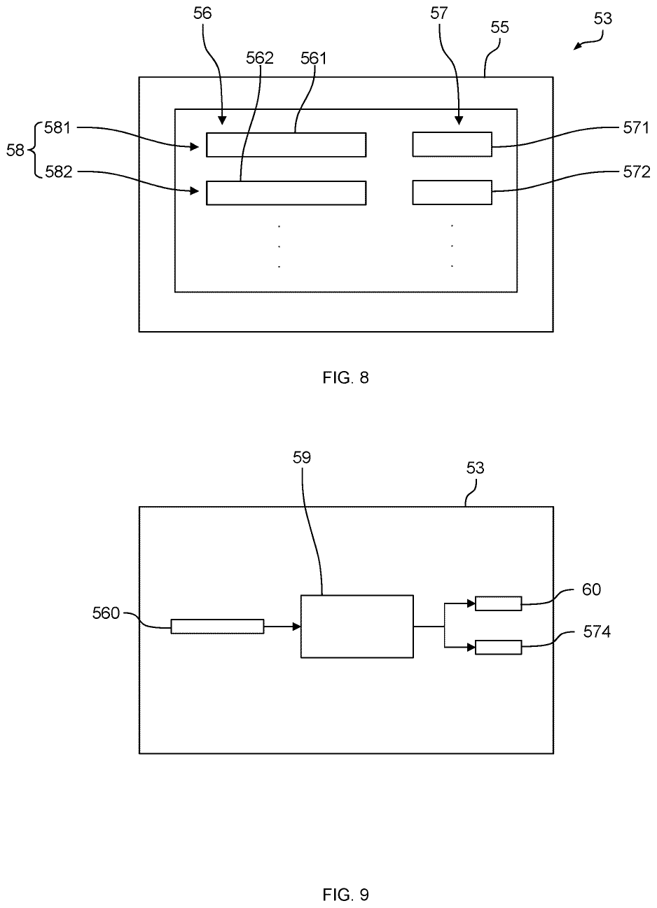

FIG. 8 shows an assessment unit according to one advantageous development; and

FIG. 9 shows an assessment unit according to one advantageous development.

Identical or functionally identical elements are denoted with the same reference signs in the figures, unless stated otherwise.

FIG. 1 shows a schematic view of an example of an ultrasonic sensor 1, and FIG. 2 shows a schematic section A-A in FIG. 1 of the example of an ultrasonic sensor 1. Reference is made to FIG. 1 and FIG. 2. The ultrasonic sensor 1 has a plastic housing 2 with a housing body 3, a retaining ring 4, a cover 5 and an extension section 6.

A diaphragm pot 9 is placed on one edge 7 of the housing body surrounding an opening 8 of the housing body 3 and secured to the housing body 3 of the plastic housing 2 with the retaining ring 4. The diaphragm pot 9 has a pot shape and a base of the top shape forms an ultrasonic diaphragm 10. Reference sign 10 designates the entire ultrasonic diaphragm and reference sign 11 designates an external surface of the ultrasonic diaphragm 10. In particular, the outer surface of the ultrasonic diaphragm 10 is bare or free. This means that the external surface 11 of the ultrasonic diaphragm is not painted (unpainted).

A piezo element 12 (an example of a sound transducer element) is fitted on an internal surface of the ultrasonic diaphragm 10 opposite the external surface 11. The piezo element 12 is electrically connected by means of two first contact pins 13 pressed into sections of the housing body 3 (only one of the first two contact pins 13 can be seen in the section view in FIG. 2) to a driver circuit 16 mounted on a printed circuit board 14 accommodated in the housing body 3. In this case, conductor paths (not shown) of the printed circuit board 14 establish the contact between the driver circuit 16 and the contact pins 13, and two fine loose wires 15 establish the contact between the contact pins 13 and the piezo element 12. The fine loose wires 15 provide vibration decoupling between the printed circuit board 10 accommodated in the rigid housing body 3 with the first contact pins 13 on the one hand, and the vibrating ultrasonic diaphragm 10 with the piezo element 12 attached to it on the other hand.

The driver circuit 16 further makes contact with at least two second contact pins 17 pressed into the housing body 3 and into the extension section 6. The second contact pins 17 provide an external electrical connection to the driver circuit 16.

FIG. 3 shows schematically a motor vehicle 80 having an ultrasonic sensor 100 and a control device 50 according to one exemplary embodiment.

The control device 50 is connected via a signal line 18 to the ultrasonic sensor 100 (with the second contact pins 17, FIG. 2). The ultrasonic sensor 100 is installed in a chassis component, such as a front fender 24, of the motor vehicle 80. The ultrasonic diaphragm 10 of the ultrasonic sensor 100 is arranged in an essentially round opening 25 of the front fender 24. It should be noted that, in FIG. 3, the representation of the size of the opening 25 and the ultrasonic diaphragm 10 is exaggerated.

The front fender 24 is a chassis component painted in a predefined color. The customer and the manufacturer therefore also need to paint the ultrasonic diaphragm 10 in the same color as the front fender 24. Thus, in FIG. 3, the external surface 11 (FIGS. 1, 2) of the ultrasonic diaphragm 10 is not free. Instead, a paint layer 26 is applied to the external surface 11 (FIGS. 1, 2) of the ultrasonic diaphragm 10. Insofar as a distinction is made below between a painted ultrasonic sensor 100 with the paint layer 26 and an unpainted ultrasonic sensor 1 without the paint layer 26, reference sign 1 is used for the unpainted ultrasonic sensor 1 (FIG. 1) and reference sign 100 for the painted ultrasonic sensor 100 (FIG. 2). Except for the paint layer, ultrasonic sensors 1, 100 are designed and configured identically. Ultrasonic sensors 1, 100 can be the same ultrasonic sensor 1, 100 before or after painting.

A routine operation of the ultrasonic sensor 1, 100 for the purpose of carrying out a distance measurement is first described schematically with reference to FIG. 1 to FIG. 3. The distance measurement operation is carried out, in particular, by a distance-measuring unit 51 of the control device 50. In distance-measurement mode, the distance-measuring unit 51 transmits a command signal via the signal line 18 to the driver circuit 16. In response to the command signal, the driver circuit 16 generates an activation signal for the piezo element 12 and outputs it via the first contact pins 13 and the fine loose wires 15 to the piezo element 12. The activation signal causes the piezo element 12 to excite the ultrasonic diaphragm 10 to produce vibrations, as a result of which an ultrasonic signal is emitted in the axial direction 19 into an environment of the motor vehicle 80. If the ultrasonic signal encounters an obstacle in the environment of the motor vehicle 80, it can be reflected back from the obstacle to the ultrasonic diaphragm 10 which it causes to vibrate. The vibrations of the ultrasonic diaphragm 10 are detected by the piezo element 12, which outputs an electrical receive signal indicative of the vibrations of the ultrasonic diaphragm 10 via the fine loose wires 15 and the first contact pins 13 to the driver circuit 16. The driver circuit 16 amplifies the electrical receive signal and transmits the amplified electrical receive signal via the second contact pins 17 and signal line 18 to the distance-measuring unit 51 of the control device 50. The distance-measuring unit 50 can then determine the distance to the obstacle in the environment of the motor vehicle 80 by means of a propagation time difference between the transmission of the ultrasonic signal (the command signal) and the reception of the reflected ultrasonic signal (the amplified electrical receive signal).

This distance-measurement mode of ultrasonic sensor 1 is influenced by a plurality of operating parameters. In particular, these are the operating frequency at which the ultrasonic diaphragm 10 is excited to produce vibrations, the amplitude of the activation signal for the piezo element 12, which correlates with an amplitude of the transmitted ultrasonic signal, and the gain with which the driver circuit 16 amplifies the electrical receive signal.

The ultrasonic sensor 1 is precalibrated during manufacture. Calibration is understood here and below to mean the setting or adaptation of the operating parameters of the ultrasonic sensor 1. The operating parameters can be stored here, for example, in the distance-measuring unit 51 and can be used to form the command signal and/or can be transmitted with each command signal to the driver circuit 16. Alternatively, however, the operating parameters can also be stored directly in the driver circuit 16 and can be set directly there during calibration.

One aim in calibrating an ultrasonic sensor 1 is to operate the ultrasonic sensor 1 at or as close as possible to a resonance frequency of the vibrating system comprising the ultrasonic diaphragm 10 and the piezo element 12 attached thereto, since the conversion efficiency of the system is optimum at the resonance frequency. The amplitude of the activation signal and the gain for the receive signal are then set, for example, experimentally through laboratory investigation in a standardized environment such that a desired signal-to-noise ratio is obtained for the amplified receive signals.

The paint layer 26, which, for example, has a thickness of 100 to 140 μm, changes the mass and rigidity of the ultrasonic diaphragm 10. The resonance frequency of the ultrasonic diaphragm 10 also changes accordingly when the ultrasonic diaphragm 10 is painted. Accordingly, the paint layer 26 has conventionally already been applied in the factory of the supplier manufacturing the ultrasonic sensor 100, and the calibration described above has been performed in the factory of the supplier on the already painted ultrasonic sensor 100.

However, scenarios are conceivable in which the paint layer 26 is intended to be applied to the ultrasonic diaphragm 10 of the unpainted ultrasonic sensor 1 only in the aftermarket. Scenarios are also conceivable in which an already painted ultrasonic sensor 100 is painted again, for example if the already used motor vehicle 80 is repainted. In these scenarios, the performance of a conventional ultrasonic sensor deteriorates in each case.

According to the exemplary embodiment, it is therefore proposed to provide the control device 50 with functionality (52-54 in FIG. 4) which enables the operating parameters of the ultrasonic sensor 1, 100 to be dynamically recalibrated during the routine operation of the motor vehicle 80, i.e. while the customer is in possession of the motor vehicle 80.

FIG. 4 shows schematically functional units 51-54 of the control device 50 according to the exemplary embodiment. FIG. 5 illustrates steps of a method for operating the ultrasonic sensor 1, 100 (FIGS. 1, 3) according to the exemplary embodiment.

In addition to the distance-measuring unit 51 described above, the control device 50 of the exemplary embodiment also comprises a characteristic-determination unit 52 (an example of a “first unit”), an assessment unit 53 and a calibration unit 54.

In step S1 of the method, the characteristic-determination unit 52 determines a sensor characteristic of the ultrasonic sensor 1, 100 (FIG. 1, FIG. 3).

In order to make it clear that a sensor characteristic can be determined during routine operation of the motor vehicle, it should first be noted that the ultrasonic diaphragm 10 (FIG. 2) having the piezo element 12 (FIG. 2) attached to it and the driver circuit 16 (FIG. 2) can in each case be regarded as components of a mechatronic system.

FIG. 6 shows a schematic equivalent circuit diagram of the mechatronic system of ultrasonic sensor 1, 100. Reference is made to FIG. 1-3 and FIG. 6. The mechatronic system can be viewed as a parallel resonance circuit having a resistor 21, an inductor 22 and a capacitor 23. A resonance frequency of the parallel resonance circuit corresponds here to a natural frequency of the ultrasonic diaphragm 10, i.e. a frequency at which the ultrasonic diaphragm 10 particularly efficiently transmits ultrasonic signals or at which the conversion efficiency of the system comprising the ultrasonic diaphragm 10 and the piezo element 12 is maximum. In other words, dissipation of electrical energy on the resistor 21 corresponds to the emission of energy in the form of an ultrasonic wave, while the inductor 22 and the capacitor 23 correspond to the flexibility and mass of the ultrasonic diaphragm 10, which influence the conversion efficiency.

It therefore becomes clear that a purely electrical characterization of the ultrasonic sensor 1, 100 is possible, which does not depend on the presence of defined laboratory conditions in the environment of the motor vehicle 80.

The sensor characteristic determined in step S1 is therefore, in particular, an analytically or numerically represented function which is determined by measuring the mechatronic system 10, 12, 16 of the ultrasonic sensor 1, 100, and which describes the response behavior of the mechatronic system 10, 12, 16 of the ultrasonic sensor 1, 100.

It should be emphasized once again that step S1 is not carried out in the factory of the supplier company, but during routine operation of the motor vehicle 80. For example, step S1 can be carried out in response to the actuation of the ignition of the motor vehicle 80 or at regular intervals.

Reference is further made to FIGS. 1, 3, 4 and 5. In step S2, following step S1, the second unit evaluates the sensor characteristic determined in step S1 in order to determine whether at least one of the operating parameters of the ultrasonic sensor 1, 100 is to be adapted. In other words, it is assessed whether the conversion efficiency of the ultrasonic sensor 1, 100 can be improved by adapting the operating parameters to the determined sensor characteristic.

If it is determined in step S2 that at least one of the operating parameters is to be adapted, the calibration unit 55 adapts the operating parameter based on the determined sensor characteristic in step S3. The operating frequency of the ultrasonic sensor 100, for example, can be changed. If this is not possible or not desired, for example due to technical constraints, the amplitude of the activation signal and/or the gain of the receive signal can also be increased. In the present exemplary embodiment, the adapted operating parameters are stored in the distance-measuring unit 51 of the control device 50 and are implemented from this time on by the distance-measuring unit 51 in subsequent distance measurements with the ultrasonic sensor 1, 100.

Accordingly, the control device 50 of the exemplary embodiment can advantageously provide a dynamic recalibration of the operating parameters of the ultrasonic sensor 1, 100 if the sensor characteristic of the ultrasonic sensor 1, 100 changes, for example due to the subsequent application of the paint layer 26 or further paint layers.

This makes it possible, for example, for an automobile supplier to deliver unpainted ultrasonic sensors 1 that are painted only subsequently (after end of line), for example by an automobile manufacturer in new vehicle production or by a service workshop if a defective ultrasonic sensor 100 is subsequently replaced with an unpainted aftermarket ultrasonic sensor 1. The automobile supplier company can thus achieve advantageous simplifications in production, whereby unpainted ultrasonic sensors 1 can be produced and delivered not only as OEM components for use in new vehicle manufacture but also as aftermarket components for use in service. An unpainted ultrasonic sensor 1 can be supplied, in particular, in a set together with a control device 50 according to the exemplary embodiment which ensures automatic recalibration of the operating parameters of the ultrasonic sensor 1 if it is first painted or repainted in its later life. This further enables automobile manufacturers to produce small series with special painting in small quantities, wherein supply-side painting would not be possible on commercial grounds. Customers can have their vehicles repainted in a different color with no adverse effects on the properties of the ultrasonic sensors 100 that are also painted.

Advantageous developments of the exemplary embodiment will now be described.

A first advantageous development is described with reference to FIG. 1 to FIG. 5. According to the first advantageous development, the sensor characteristic determined by the characteristic-determination unit 52 in step S1 is a transmission function of the mechatronic components (the ultrasonic diaphragm 9 having the piezo element 12 attached to it and the driver circuit 16) of the ultrasonic sensor 1, 100. The characteristic-determination unit 52 impresses a voltage signal U(t) as a test signal on the ultrasonic sensor 1, 100 in order to determine the transmission function, and measures the current response I(t) of the ultrasonic sensor 1, 100 to the voltage signal U(t) in order to determine the transmission function.

In particular, the test voltage signal U(t) can preferably comprise a plurality of signal components having different frequencies. The test voltage signal U(t) can particularly preferably be a pulse-shaped impact excitation. The test voltage signal U(t) and the current response signal I(t) are then transferred to the frequency domain by Fourier or Laplace transformation and are divided by one another to obtain the transmission function. However, instead of the pulse-shaped impact excitation, a plurality of, for example sinusoidal, test voltage signals Uₙ(t) can also be impressed successively at different frequencies fₙ, and respective current response signals Iₙ(t) can be captured. In this case also, measuring points can be constructed in the frequency domain and the transmission function can be obtained by dividing curves fitted to the measuring points in the frequency domain.

Accordingly, a purely electrical characterization of the ultrasonic sensor 1, 100 can advantageously take place. The resonance frequency and the frequency-dependent conversion efficiency of the ultrasonic diaphragm 10 of the ultrasonic sensor 1, 100 can advantageously be derived from the determined transmission function (an example of the signal characteristic). It can serve accordingly as a basis for determining suitable operating parameters of the ultrasonic sensor 1, 100 which can then be implemented (adapted) accordingly by the third unit in step S3.

FIG. 7 shows a flow diagram illustrating the processing of the assessment unit 53 of further advantageous developments of the exemplary embodiment. In other words, FIG. 7 shows advantageous details of a design of step S2 in FIG. 5.

A second advantageous development is described with reference to FIGS. 1, 3, 4 and 7. In step S21, in decision block S211 according to the second advantageous development, the assessment unit 53 first assesses the need (requirement) for an adaptation of the operating parameters of the ultrasonic sensor 1, 100. To do this, for example, the assessment unit 53 compares a sensor characteristic which is stored in a memory area of the assessment unit 53 and which corresponds to currently set operating parameters of the ultrasonic sensor 1, 100 with the sensor characteristic determined in step S 1. The assessment unit 53 determines, for example, a similarity parameter which indicates a deviation between the sensor characteristics. The similarity parameter can be, for example, a correlation coefficient or an integral over a difference in the sensor characteristics. If a deviation indicated by the similarity parameter between the stored sensor characteristic and the determined sensor characteristic is greater than a predefined threshold value, the assessment unit 53 decides that an adaptation of the operating parameters of the ultrasonic sensor 100 is necessary (Y at S211 in FIG. 7). Otherwise, the assessment unit 53 decides that no adaptation is necessary (N at S211 in FIG. 7) and the method ends. Unnecessarily frequent recalibrations can thus be avoided. Otherwise (Y at S211 in FIG. 7), the method continues with step S22.

In step S22, the assessment unit 53 assesses the expediency of adapting the operating parameters of the ultrasonic sensor 1, 100. An adaptation will be considered particularly expedient if it is assessed in step S22 that the deviation identified in step S21 is due to a paint coating (application of the paint layer 26 or addition of an additional further paint layer to the outer surface 11 of the ultrasonic diaphragm 10) of the ultrasonic sensor 100. Details of the decision as to whether the deviation is due to a paint coating are discussed below with reference to a plurality of further advantageous developments.

Reference is made to FIGS. 3, 4 and 7. According to a third advantageous embodiment, the assessment unit 53 first executes the decision block S221 in step. At decision block S221, the assessment unit 53 checks whether the deviation identified in step S21, i.e. the similarity parameter, is less than a second predefined threshold value which is greater than the (first) predefined threshold value, which is less than the similarity parameter. This means that the assessment unit 53 checks whether the similarity parameter lies between a first and a second threshold value. If not, i.e. if the similarity parameter exceeds the second threshold value also, the method ends (N at S221). In this case, it is assumed that the deviation is so great that it is not due to a paint coating on the ultrasonic diaphragm 10, but due to another fault condition due to e.g. dirt or ice. Otherwise (Y at S221), the method continues with decision block S222.

In addition, according to a particularly preferred optional design of the third development, the method further branches to “Y” in decision block S221 only if the deviation already lies above the first threshold value and optionally below the second threshold value over a predetermined number of ignition cycles of the motor vehicle 80 (FIG. 3). Otherwise, the method branches to “N” even if the deviation lies above the first threshold value and below the second threshold value, and the method ends. In other words, the expediency of recalibration is identified only if the deviation is not excessive and remains stable over a certain period of time.

Reference is made to FIGS. 1, 3, 4 and 7. According to a fourth advantageous development, the assessment unit 53 also executes decision block S222 in step S22. In decision block S222, the assessment unit 53 causes the distance-measuring unit 51 to carry out distance measurements with the ultrasonic sensor 1, 100 and with a plurality of further ultrasonic sensors (not shown) of the motor vehicle 80. If it is determined that the distance measurements performed with different ultrasonic sensors 1, 100 or at time intervals with the same ultrasonic sensor 1, 100 differ substantially from one another and do not show a congruent picture of the environment of the motor vehicle 80 and/or if the distance measurement performed with the ultrasonic sensor 1, 100 indicates an obstacle in the immediate vicinity of the ultrasonic sensor 100, the assessment unit 53 assesses that an adaptation of the operating parameters of the ultrasonic sensor 100 based on the determined characteristic is not currently expedient (N at decision block S222) since the modified sensor characteristic of the ultrasonic sensor 100 is possibly due to a temporary impairment, such as dirt or ice on the ultrasonic diaphragm 10, or a different obstacle in the vicinity of the ultrasonic sensor 1, 100, and the method ends. Otherwise (Y at S221), either the expediency of an adaptation can be identified or, as shown in FIG. 7, the method continues with decision block S223.

FIG. 8 shows an assessment unit 53 according to a fifth advantageous development. Reference is made to FIGS. 1, 3 and 8. A lookup table 55 is stored in the assessment unit 53 of the fifth development. A plurality of predefined sensor characteristics 56 and a plurality of sets of operating parameter values 57 are stored in the lookup table 55. A respective data set 58 in the lookup table in each case comprises one of the sensor characteristics 56 and an associated set of the sets of operating parameter values 57. The data sets 58 are created by the supplier and are saved in the lookup table 55. Data sets 58 are measured by means of calibration measurements performed in a laboratory environment with corresponding measuring devices on different configurations of the ultrasonic sensor 1, 100. For example, a first data set 581 can comprise a sensor characteristic 561 determined on the unpainted ultrasonic sensor 1 (FIG. 1) and associated operating parameters 571 determined as optimum through laboratory experiments with corresponding laboratory equipment on the unpainted ultrasonic sensor 1 (FIG. 1). A second data set 582 of the data sets 58 can comprise a sensor characteristic 562 determined on the painted ultrasonic sensor 100 and associated operating parameter values 572 determined as optimum on the painted ultrasonic sensor 100. Further data sets of the data sets 58 can comprise sensor characteristics 56 determined on ultrasonic sensors 100 provided with other types of paint or with multiple paint layers 26 and associated operating parameter values 57 determined as optimum. In this way, an automobile supplier can measure many expected scenarios with different expected paint consistencies and numbers of paint layers 26 in the laboratory and can store the resulting information relating to sensor characteristics 56 and associated optimum operating value sets 57 in the lookup table 55 of the assessment unit 53.

Reference is made to FIGS. 1, 3, 7 and 8. According to the fifth development, the assessment unit 53 further executes decision block S223 in step S22 in order to assess whether a deviation detected in step S21 is due to a paint coating. In decision block S223, the assessment unit 53 compares the sensor characteristic determined in step S1 (FIG. 5) with each of the sensor characteristics 56 stored in the lookup table 53. In the same way as in decision block S21, a deviation between the sensor characteristic defined in step S1 and the respective sensor characteristic 56 from the lookup table 55 can be determined here and a match can be identified if the deviation is less than a predefined threshold value.

If a match is identified in the comparison described above, the assessment unit 53 assesses that an adaptation of the operating parameters of the ultrasonic sensor 1, 100 is expedient due to a change in the paint coating, and must therefore be carried out (Y in decision block S223). In this case, the assessment unit 53 looks up, in the lookup table 55, the operating parameter values 57 associated with the matching sensor characteristic from the sensor characteristics 56 and forwards the associated set of operating parameters 574 to the calibration unit 54 for implementation.

If no match is identified (N in decision block S223), the method can end without recalibration. Alternatively, however, according to a sixth advantageous development, the assessment unit 53 continues with decision block S224.

FIG. 9 shows an assessment unit 53 according to the sixth advantageous development. Reference is made to FIGS. 1, 3 and 9. The assessment unit 53 of the sixth advantageous development has a model 59. The model 59 is configured to output an assessment 60 in response to an input into the model 59 of the sensor characteristic 560 specified in step S1 (FIG. 5), indicating whether an adaptation of the operating parameters of the ultrasonic sensor 1, 100 may be expedient, since, according to the model, the determined sensor characteristic 560 is assessed as consistent with one of a plurality of painting scenarios of the ultrasonic diaphragm 10 (FIGS. 1, 3). Moreover, the model 59 is configured, at least if the assessment 60 produces a positive result, to further output, in response to the input of the determined sensor characteristic 560, operating parameters 574 which promise an efficient operation of an ultrasonic sensor 1, 100 with the determined sensor characteristic 560.

Reference is again made to FIGS. 1, 3, 7 and 9. In decision block S224, the assessment unit 53 of the fifth development enters the sensor characteristic 560 determined in step S1 (FIG. 5) into the model 59 and assesses according to the assessment 60 whether the operating parameters are to be adapted. If so (Y at S224), the set of operating parameters 574 output by the model is provided to the calibration unit 54 for implementation. If not (N at S224), an adaptation of the operating parameters is not expedient, and the method ends without recalibration.

In some variants, the model 59 of the sixth development can be a physical model which derives the assessment 60 and the proposed set of operating parameter values 574 by analytical means. In other variants, the model 59 can be a data-based model, such as a statistical model with a plurality of adaptable parameters, or a neural network, such as, for example, a deep neural network. The parameters of the statistical model or the triggering probabilities for neurons of the deep neural network may have been suitably trained by the supplier through training with training data sets. In particular, the training data sets that are used can be the same data sets 58 as those described in detail with reference to FIG. 8 for the fifth development as stored in the lookup table 55. In other words, the data-based model 59 may have been trained with predefined sensor characteristics 56 as training input data and with the associated optimum operating parameter values 57 determined experimentally in a laboratory environment as training output data.

Although the present invention has been described on the basis of exemplary embodiments, it is modifiable in a variety of ways. Features that have been disclosed for different developments of the exemplary embodiment can be combined in any suitable manner with each other and with the features of the exemplary embodiment and/or can be individually selected, provided that no inconsistencies are created as a result.

In particular, if the complete method shown in FIG. 7 is carried out, the assessment unit 53 can have both the lookup table 55 (FIG. 8) and the model 59 (FIG. 9). However, the lookup table 55 and the associated decision block S223 can also be omitted. This applies in particular if the decision block S224 with the model-based assessment is present, though this in turn is optional. The assessment of the expediency of adapting the operating parameters on the basis of the plurality of environmental measurements (decision block S222) as well as the assessment of the necessity and/or expediency on the basis of the comparison with a stored sensor characteristic (decision blocks S211, S221) are in each case optional features also.

Various further developments describe that the operating parameter values 574 to which the operating parameters of the calibration unit 54 are to be adapted are obtained from a lookup table 55 and/or are determined by a model 59. However, it is also conceivable for the operating parameters 574 to which the operating parameters of the ultrasonic sensor 1, 100 are to be adapted to be derived directly from the sensor characteristic 560 defined in step S1. For example, if the sensor characteristic 560 is a transmission function, the operating frequency of the ultrasonic sensor 1, 100 can be adapted, for example, to a frequency at which the transmission function has a maximum (resonance frequency). However, if it is decided to leave the operating frequency at different frequency, the amplitude of the activation signal and/or the gain of the receiving signal can be selected depending on a ratio of the value of the transmission function at the different frequency to the value of the transmission function at the maximum, thus compensating through amplification for a conversion efficiency reduced as a result of the shifted position of the operating frequency.

According to the exemplary embodiment, the functionality of the characteristic-determination unit 52 (first unit 52), the assessment unit 53 (second unit 53) and the calibration unit 54 (third unit 54) together with the distance-measuring unit 51 is integrated into a common control device 50. However, it is also conceivable for the characteristic-determination unit 52 (first unit 52), the assessment unit 53 (second unit 53), and the calibration unit 54 (third unit 54) to be provided in a separate control device which, when installed in a motor vehicle 80, has a communication connection via the signal line 18 to a distance-measuring control device containing the distance-measuring unit 51. Accordingly, the distance-measuring unit 51 is not a necessary feature of the proposed control device 50. It is further conceivable for the functionality of the characteristic-determination unit 52 (first unit 52), the assessment unit 53 (second unit 53), and the calibration unit 54 (third unit 54) to be integrated into the ultrasonic sensor 1, 100, so that the ultrasonic sensor 1, 100 can also be an ultrasonic sensor 1, 100 having an integrated control device 52-54. REFERENCE SIGN LIST
1 Ultrasonic sensor
2 Plastic housing
3 Housing body
4 Retaining ring
5 Cover
6 Extension section
7 Edge of the housing body
8 Opening in the housing body
9 Diaphragm pot
10 Ultrasonic diaphragm
11 Outer surface of the ultrasonic diaphragm
12 Piezo element
13 First contact pins
14 Printed circuit board
15 Fine loose wires
16 Driver circuit
17 Second contact pins
18 Signal line
19 Axial direction
20 Equivalent circuit diagram
21 Resistor
22 Inductor
23 Capacitor
24 Front fender
25 Opening in the front fender
26 Paint layer
50 Control device
51 Distance-measuring unit
52 Characteristic-determination unit
53 Assessment unit
54 Calibration unit
55 Lookup table
56 Predefined sensor characteristics
57 Associated operating parameters
58 Data set
59 Model
60 Assessment
80 Motor vehicle
100 Ultrasonic sensor
560 Determined sensor characteristic
561-562 Predefined sensor characteristics
571-572 Associated operating parameter values
574 Operating parameter values to which the operating parameters are to be adapted
581-582 Data sets
S1-S3 Method steps
S21, S22 Method steps, substeps of step S2
S211 Decision block
S221-S224 Decision blocks

1. A control device for an ultrasonic sensor of a motor vehicle which comprises:
a first unit configured to determine a sensor characteristic of the ultrasonic sensor during routine operation of the motor vehicle;
a second unit configured to assess the determined sensor characteristic in order to establish whether an operating parameter of the ultrasonic sensor is to be adapted; and
a third unit configured to adapt the operating parameter of the ultrasonic sensor based on the determined sensor characteristic if the second unit assesses that the operating parameter is to be adapted.

2. The control device as claimed in claim 1, wherein the assessment by the second unit comprises determining a deviation of the determined sensor characteristic from a sensor characteristic stored in the second unit which corresponds to current operating parameter values of the ultrasonic sensor.

3. The control device as claimed in claim 2, wherein the assessment by the second unit comprises assessing whether an identified deviation of the determined sensor characteristic from the stored sensor characteristic is due to a paint coating of an ultrasonic diaphragm of the ultrasonic sensor, and assessing that the operating parameter is to be adapted only if the identified deviation is due to a paint coating of the ultrasonic diaphragm.

4. The control device as claimed in claim 1, wherein the second unit is configured to assess whether the operating parameter is to be adapted by comparing a first distance measurement performed with the ultrasonic sensor with a second distance measurement performed with the same or a further ultrasonic sensor.

5. The control device as claimed in claim 1,
wherein the second unit stores a lookup table containing a plurality of predefined sensor characteristics and associated operating parameter values that were determined in advance through measurements on differently painted ultrasonic sensors under laboratory conditions,
wherein the second unit is configured to assess, by comparing the determined sensor characteristic with the plurality of predefined sensor characteristics, whether the operating parameter is to be adapted and/or, by referring to the lookup table, to determine an operating parameter value to which the operating parameter is to be adapted by the third unit.

6. The control device as claimed in claim 1
wherein the second unit comprises a physical or data-based model configured to output an assessment, based on a sensor characteristic entered into the model, of whether an operating parameter is to be adapted, and/or to output an operating parameter value to which the operating parameter is to be adapted,
wherein the second unit is configured to enter the determined sensor characteristic into the physical or data-based model and to use the physical or data-based model to assess whether the operating parameter is to be adapted and/or to determine an operating parameter to which the operating parameter is to be adapted by the third unit.

7. The control device as claimed in claim 6, wherein the data-based model comprises one or more trained neural networks.

8. The control device as claimed in claim 1,
wherein the respective sensor characteristic determined by the first unit is a transmission function of mechatronic components of the ultrasonic sensor,
wherein the first unit is configured to impress an electrical test signal on the ultrasonic sensor and to capture an electrical response signal from the ultrasonic sensor in order to determine the sensor characteristic.

9. The control device as claimed in claim 1, wherein the operating parameter that is adapted by the third unit comprises one or more of the following parameters:
an operating frequency at which an ultrasonic diaphragm of the ultrasonic sensor is excited to produce vibrations,
an amplitude of an activation signal with which a driver circuit of the ultrasonic sensor activates a sound transducer element of the ultrasonic sensor, and
an amplification with which a receive signal output by the sound transducer element to the driver circuit is amplified.

10. A method for operating an ultrasonic sensor of a motor vehicle, comprising:
determining a sensor characteristic of the ultrasonic sensor during routine operation of the motor vehicle;
assessing the determined sensor characteristic in order to establish whether an operating parameter of the ultrasonic sensor is to be adapted; and
adapting the operating parameter of the ultrasonic sensor based on the determined sensor characteristic if it has been assessed that the operating parameter is to be adapted.

11. A non-transitory computer readable medium comprising a computer program product, comprising instructions which, when executed by a control unit of a motor vehicle, cause the control unit to carry out the method as claimed in claim 10.

12. An ultrasonic sensor comprises:
an ultrasonic diaphragm;
a sound transducer element arranged on an inside of the ultrasonic diaphragm for vibration excitation and vibration detection of the ultrasonic diaphragm;
a driver circuit to activate the sound transducer element; and
the control device as claimed in claim 1.

13. A set, comprising:
the control device as claimed in claim 1;
an ultrasonic sensor which has an ultrasonic diaphragm;
a sound transducer element arranged on an inside of the ultrasonic diaphragm for vibration excitation and vibration detection of the ultrasonic diaphragm; and
a driver circuit to activate the sound transducer element.

14. The ultrasonic sensor as claimed in claim 12, wherein the ultrasonic diaphragm of the ultrasonic sensor is without at least a final paint coating.

15. A motor vehicle having a control device as claimed in claim 1.
